(19) United States
(12) Patent Application Publication
(10) Pub. No.: US 2024/0043110 A1
(43) Pub. Date: Feb. 8, 2024

(54) SYSTEM AND METHOD FOR ADDRESSING REDUNDANT SENSOR MISMATCH IN AN ENGINE CONTROL SYSTEM

(71) Applicant: Pratt & Whitney Canada Corp., Longueuil (CA)

(72) Inventors: Alireza Gharagozloo, Boucherville (CA); Roja Tabar, Boucherville (CA)

(21) Appl. No.: 17/879,464

(22) Filed: Aug. 2, 2022

(51) Int. Cl. B64C 13/02; G07C 5/00

(52) U.S. Cl. CPC B64C 13/02; G07C 5/004

(57) ABSTRACT

A method and system for processing parameter values from a redundant sensor configured to sense a parameter used in the control of an aircraft engine is provided. The method includes: a) receiving a plurality of parameter values from a redundant sensor by sensing the same parameter at the same time; b) identifying mismatched parameter values; c) producing a predicted parameter value using an artificial intelligence (AI) model having a database of parameter values representative of the sensed parameter; d) providing the predicted parameter value to a control unit; and e) operating the control unit to select a first parameter value or a second parameter value using the predicted parameter for use in the control of the aircraft engine.

### BACKGROUND OF THE INVENTION

### 1. Technical Field

The present disclosure relates to engine control systems and methods in general, and to systems and methods for addressing redundant sensor mismatch in an engine control system.

### 2. Background Information

Modern aircraft electronic control systems include various redundant components, such as a dual-channel Engine Control Unit (ECU), sensors that provide input signals to the ECU, and actuators commanded by ECU output signals to measure engine parameters. Sensors are often electrically redundant, but are mechanically prone to failures (e.g., FOD exposure, material fatigue, installation degradation etc.). Engine and aircraft manufacturers mitigate the potential for failure by using multiple sensors, albeit at an increase in cost and system complexity. Engine sensor failures can occur in a variety of different ways (e.g., sending out-of-range signals, mismatch errors, etc.) that can be detected with control system logic and be accommodated via the redundant source of the signal.

The term “mismatch error” refers to a scenario wherein redundant sensors (e.g., a sensor having a plurality of channels) each produce signal values representative of a function or a parameter being sensed within a range indicating that the component is operating properly (i.e., the signals are “in-range”), but the redundant sensors or sensor channels are producing signal values different from one another while sensing the same parameter. The disparity between the signals produced by the redundant sensors provides uncertainty regarding which sensor output is accurate and which is skewed signal data. Existing aircraft electronic control systems of which we are aware do not have the capability to establish the integrity and validity of the redundant sensor signals.

What is needed is an aircraft electronic control system that can accommodate sensor discrepancies and in particular discrepancies between redundant sensors such as mismatch errors.

### SUMMARY

According to an aspect of the present disclosure, a method for processing parameter values from a redundant sensor configured to sense a parameter used in the control of an aircraft engine, the redundant sensor disposed within an aircraft is provided. The method includes: a) producing a plurality of parameter values from a redundant sensor, the plurality of parameter values including first parameter values and second parameter values produced by the redundant sensor sensing the same parameter at the same time; b) identifying mismatched parameter values from the plurality of parameter values, wherein the mismatched parameter values include a respective first parameter value and a respective second parameter value produced by sensing the same parameter at the same time and the respective first parameter value and the respective second parameter value do not equal one another; c) producing a predicted parameter value using an artificial intelligence (AI) model having a database of parameter values representative of the sensed parameter; d) providing the predicted parameter value to a control unit; and e) operating the control unit to select the respective first parameter value or the respective second parameter value using the predicted parameter for use in the control of the aircraft engine.

In any of the aspects or embodiments described above and herein, the redundant sensor may have a plurality of channels and the respective first parameter value may be produced by a first channel of the redundant sensor and the respective second parameter value may be produced by a second channel of the redundant sensor.

In any of the aspects or embodiments described above and herein, the database of parameter values representative of the sensed parameter may include data representative of parameter values previously collected from the aircraft.

In any of the aspects or embodiments described above and herein, the predicted parameter value may at least in part be based on the data representative of parameter values previously collected from the aircraft included within the database.

In any of the aspects or embodiments described above and herein, the predicted parameter value may at least in part be based on operational data values collected at the time the mismatched parameter values are produced.

In any of the aspects or embodiments described above and herein, the method may further include the step of storing the plurality of parameter values from the redundant sensor produced during a mission of the aircraft.

In any of the aspects or embodiments described above and herein, the method may further include the step of downloading the stored plurality of parameter values from the redundant sensor produced during the mission of the aircraft to a remote system portion for processing into a form for updating the AI model.

In any of the aspects or embodiments described above and herein, the remote system portion may be ground based, cloud based, or some combination thereof.

In any of the aspects or embodiments described above and herein, the method may further include the step of storing the plurality of parameter values from the redundant sensor produced during a mission of the aircraft and updating the AI model based on the plurality of parameter values from the redundant sensor produced during the mission of the aircraft.

In any of the aspects or embodiments described above and herein, the plurality of parameter values from the redundant sensor may be within a range indicating that a sensed portion of the aircraft engine is operating properly.

In any of the aspects or embodiments described above and herein, the sensed parameter may be one or more of pressure, temperature, aircraft altitude, speed, acceleration, power, torque, weight, or aircraft ambient conditions.

According to another aspect of the present disclosure, a control system for an aircraft engine of an aircraft is provided that includes an electronic control unit (ECU), a redundant sensor, and an engine data recorder (EDR). The redundant sensor is disposed within the aircraft and in communication with the ECU. The redundant sensor is configured to sense a parameter used in the control of the aircraft engine, and to produce a plurality of parameter values including first parameter values and second parameter values by sensing the parameter at the same time. The EDR is in communication with the ECU, and the EDR has an artificial intelligence (AI) model having a database of parameter values representative of the sensed parameter. The ECU is configured to identify mismatched parameter values from the redundant sensor, wherein the mismatched parameter values include respective first and second parameter values produced by sensing the same parameter at the same time and the respective first and second parameter values do not equal one another. The EDR is configured to produce a predicted parameter value using the AI model and to selectively communicate the predicted parameter value to the ECU. The ECU is configured to select at least one first parameter value or at least one second parameter value using the predicted parameter for use in the control of the aircraft engine.

In any of the aspects or embodiments described above and herein, the EDR may be configured to store the plurality of parameter values from the redundant sensor produced during a mission of the aircraft, and may be configured to selectively download the stored plurality of parameter values from the redundant sensor to a remote system portion for processing into a form for updating the AI model.

In any of the aspects or embodiments described above and herein, the EDR may be configured to store the plurality of parameter values from the redundant sensor produced during a mission of the aircraft and to update the AI model based on the plurality of parameter values.

According to an aspect of the present disclosure, a method for processing parameter values from redundant sensors configured to sense a parameter used in the control of an aircraft engine is provided. The redundant sensors are disposed within an aircraft. The method includes: a) producing a plurality of first parameter values from a first sensor configured to sense a parameter; b) producing a plurality of second parameter values from a second sensor configured to sense the parameter; c) wherein the first sensor and the second sensor are configured to be redundant, sensing the parameter at the same time; d) identifying a mismatch between the first parameter values and the second parameter values, wherein the first parameter values and the second parameter values produced by sensing the parameter at the same time do not equal one another; e) producing a predicted parameter value using an artificial intelligence (AI) model having a database of parameter values representative of the sensed parameter; f) providing the predicted parameter value to a control unit; and g) operating the control unit to select at least one of the first parameter values or at least one of the second parameter values using the predicted parameter for use in the control of the aircraft engine.

The foregoing features and elements may be combined in various combinations without exclusivity, unless expressly indicated otherwise. For example, aspects and/or embodiments of the present disclosure may include any one or more of the individual features or elements disclosed above and/or below alone or in any combination thereof. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 is a diagrammatic sectional view of a gas turbine engine.

FIG. 2 is a schematic diagram of a present disclosure system embodiment.

FIG. 3 is a schematic diagram of a present disclosure system embodiment.

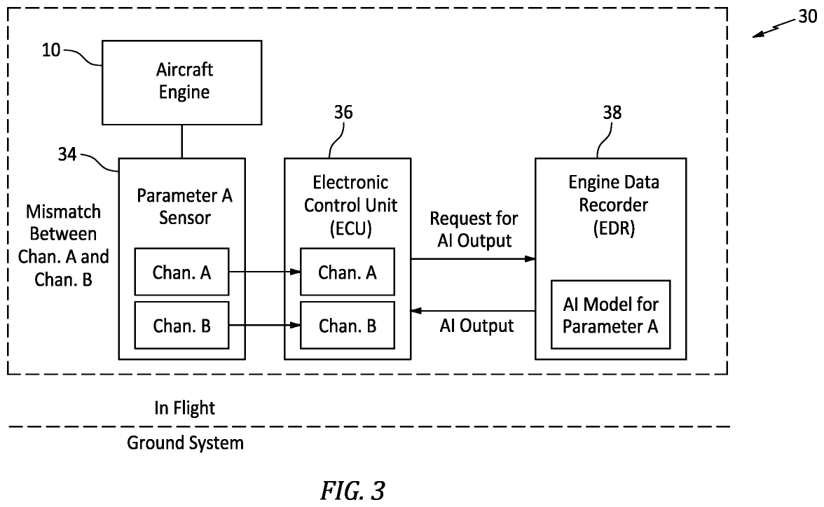

### DETAILED DESCRIPTION

The present disclosure is directed to systems and methods used to control operational aspects of an aircraft engine. Modern aircraft (fixed wing or rotary blade) utilize a variety of different types of engine control systems including, but not limited to full authority digital engine controls (FADEC), electronic engine controls (EEC), engine control units (ECU), digital engine controls (DEC) and the like. The present disclosure may be utilized in a variety of different engine control systems and is therefore not limited to use with any particular type of control system. To simplify the description herein, the present disclosure will be described in terms of an electronic control unit (ECU) but is not limited to use therewith.

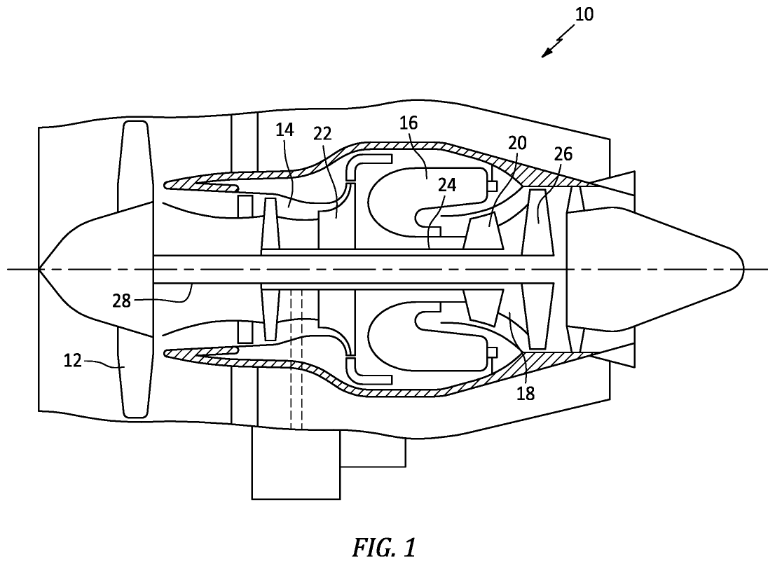

FIG. 1 illustrates an exemplary gas turbine engine 10 of a type preferably provided for use in subsonic flight. The engine 10 includes a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. High pressure rotor(s) 20 of the turbine section 18 are drivingly engaged to high pressure rotor(s) 22 of the compressor section 14 through a high pressure shaft 24. Low pressure rotor(s) 26 of the turbine section 18 are drivingly engaged to the fan 12 rotor and to other low pressure rotor(s) (not shown) of the compressor section 14 through a low pressure shaft 28 extending within the high pressure shaft 24 and rotating independently therefrom. Although illustrated as a turbofan engine in FIG. 1, the present disclosure is applicable to a variety of other types of gas turbine engines including turboshaft engines as well as other types of aircraft engines such as auxiliary power units (APUs), rotary engines, electric engines, and hybrid electric propulsion systems having a propeller driven in a hybrid architecture (series, parallel, or series/parallel) or turboelectric architecture (turboelectric or partial turboelectric).

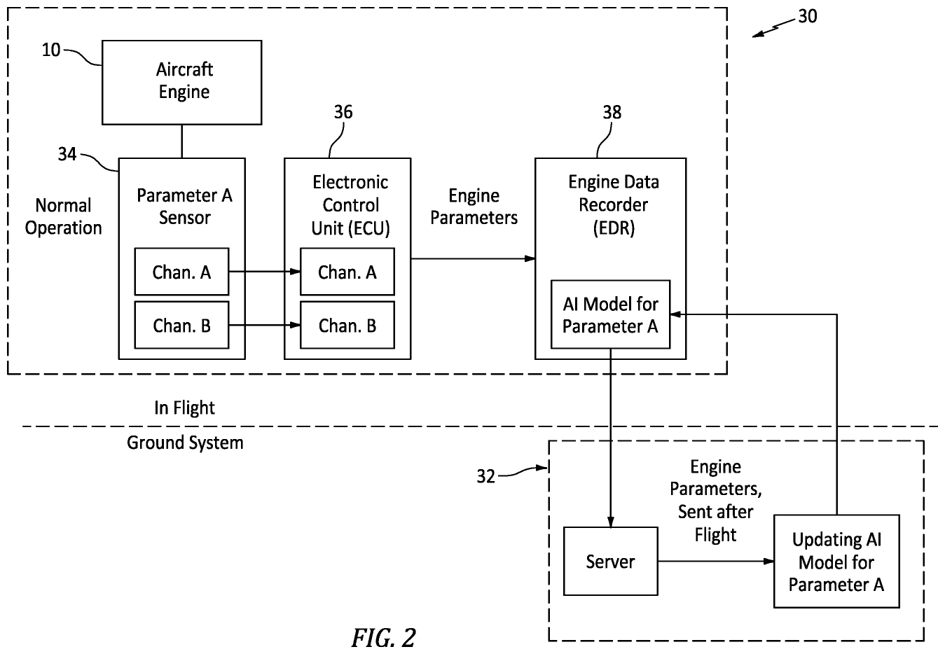

FIG. 2 schematically illustrates a present disclosure system that includes an aircraft 30 and a remote system portion 32 (i.e., remote relative to the aircraft) in accordance with one or more embodiments of the present disclosure. The aircraft 30 has an engine 10 (e.g., such as that shown in FIG. 1) and includes a sensor 34 sensing a “Parameter “A”, an electronic control unit (ECU) 36, and an engine data recorder (EDR) 38. The schematic illustration of the aircraft 30 having a sensor 34 for sensing Parameter A (which sensor 34 is hereinafter referred to as “Sensor A”) is for explanation purposes and to simplify the description herein. The present disclosure is applicable to aircraft systems having a plurality of sensors 34 configured to sense a variety of different parameters. The present disclosure is not limited to any particular type of sensor 34. The term “Parameter A” is used herein to generically refer to any type of parameter that can be sensed in an aircraft application that may be considered by the ECU 36. Nonlimiting examples of parameters that may be sensed by a sensor 34 include pressure (e.g., engine inlet total pressure, interstage pressure, engine pressure ratio or EPR), temperature (e.g., engine inlet total temperature, turbine inlet temperature, interstage temperature, engine exhaust gas temperature or EGT), altitude, speed (e.g., rotor speed of the engine's low-pressure rotor and high-pressure rotor, measured in RPM), acceleration, power, torque, flight and ambient conditions (e.g., ambient pressure and temperature), aircraft loading (e.g., weight of the aircraft, weight of fuel, etc., which may be determined directly or indirectly), and the like. Sensor A may be configured to produce signal data representative of Parameter A in real-time or at regular intervals during a flight mission of the aircraft 30.

The ECU 36, EDR 38, and other components within the present disclosure system may each include a controller that may be in communication with other system components (e.g., sensors, effectors, etc.) to receive signals from and/or transmit signals to that component to perform the functions described herein. A controller may include any type of computing device, computational circuit, processor(s), CPU, computer, or the like capable of executing a series of instructions that are stored in memory. The instructions may include an operating system, and/or executable software modules such as program files, system data, buffers, drivers, utilities, and the like. The executable instructions may apply to any functionality described herein to enable the system to accomplish the same algorithmically and/or coordination of system components. A controller may include or be in communication with one or more memory devices. The memory device may store instructions and/or data in a non-transitory manner. Examples of memory devices that may be used include read-only memory, random access memory, volatile memory, non-volatile memory, static memory, dynamic memory, flash memory, cache memory, and/or any device that stores digital information. Communications between the controller and other system components may be via a hardwire connection.

The ECU 36 may include a controller and is configured to perform a variety of tasks, including receiving data signals from sensors 34 that sense aircraft operating parameters such as those listed above. The ECU 36 continuously analyzes the sensor data signal inputs and sends commands to control components (e.g., effectors such as solenoids, motors, actuators, valves, and the like) to control engine performance and provide the desired performance while keeping the engine within safe and efficient engine operating parameters. An ECU 36 typically has the ability to automatically detect issues within the aircraft, an engine, or the ECU 36 itself and includes logic designed to mitigate those issues through backup functions or reverting to a safe operating state. The ECU 36 also communicates data (e.g., engine parameter data) to the EDR 38. The data communicated by the ECU 36 to the EDR 38 may be raw data or processed data, or any combination thereof.

The ECU 36 may be configured to communicate data to the EDR 38 in real-time or at regular intervals during a flight mission of the aircraft 30. In some embodiments, the ECU 36 may be configured to communicate certain data to the EDR 38 during a flight mission of the aircraft 30 (in real-time or intervals) and other data may be communicated at the end of the aircraft's flight mission. As used herein, the term “mission” refers to a flight to perform a specific task. The mission may be defined by various parameters, such as flight speeds, altitudes, duration, destination, weight, and any flying parameters to be used during the mission.

The EDR 38 may include a controller and is configured to store sensor data communicated to the EDR 38 from the ECU 36. The EDR 38 is configured to store sensor data communicated to the EDR 38 from the ECU 36 for a current flight, and may be configured to store sensor data communicated to the EDR 38 from the ECU 36 for one or more previous flights. The EDR 38 includes an artificial intelligence (AI) model configured to model parameter data (e.g., such as Parameter A) under engine operating conditions, including on ground operating conditions and in flight operating conditions. The EDR 38 is configured to selectively communicate with the remote system portion 32; e.g., send parameter data—raw or processed—to a server disposed within the remote system portion 32, and receive data and/or instructions (e.g., executable AI model files, an updated version of the AI model stored within the EDR 38, etc.) from the remote system portion 32.

The remote system portion 32 is disposed remote from the aircraft 30 (e.g., ground based, cloud based, etc.) and may include one or more controllers (e.g., a server) configured to receive parameter data—raw and/or processed—from the EDR 38. The same controller or another controller in communication with the remote system portion 32 is configured with the AI model for Parameter A that may be updated with parameter data received from the EDR 38. The present disclosure is not limited to any particular means of communicating between the EDR 38 and the remote system portion 32; e.g., the communication may be made by wired connection, wireless connection, or via a portable device used to download the data.

As indicated above, aircraft control systems often employ redundant sensors 34 (independent of one another) or a redundant sensor 34 having a plurality of sensing channels. The present disclosure is described herein in terms of a redundant sensor 34 having a plurality of sensing channels but is not limited thereto. Under normal operations with a redundant sensor 34 (e.g., Sensor A) that is configured to produce data signals representative of sensed Parameter A in each of a plurality of channels (e.g., two or more channels, such as Channel A and Channel B), the parameter values in each channel equal one another. In this scenario, the ECU 36 will select the parameter value from one of the channels for further processing as part of the control of the engine. It should be noted that in some embodiments, an ECU 36 may be configured to evaluate the parameter values from the different sensor channels to determine if a difference exists. If a parameter value difference does exist, the difference may be evaluated against a “mismatch difference threshold”. If the magnitude of difference between the mismatched parameter values is below the mismatch difference threshold, then the difference between the mismatched parameter values may be ignored (e.g., the mismatched data signal although different are so close that they are functionally equivalent for operational purposes) and the parameter values may be processed in the same manner as if the parameter values equaled one another. Conversely, if the magnitude of difference between the mismatched parameter values is great enough such that the difference cannot be ignored (but the mismatched parameter values are still in-range), then one of the mismatched parameter values likely must be selected for further processing as part of the control of the engine.

Conventional control systems often addressed mismatched parameter values (i.e., different but still in-range) from a redundant sensor 34 by configuring the ECU 36 to select a value that is “safer” or “more conservative” for operational purposes. For example, a difference in rotor speed parameter values from a redundant sensor 34 (e.g., a first rotor speed value in a first channel and a second rotor speed value in a second channel, where the first rotor speed value does not equal the second rotor speed value) may be addressed by ECU logic that selects the higher rotor speed parameter value to mitigate the possibility of a rotor overspeed condition. As another example, when a redundant sensor 34 produces a difference in inlet temperature values (e.g., a first inlet temperature value in a first channel and a second inlet temperature value in a second channel, where the first inlet temperature value does not equal the second inlet temperature value), some prior art applications address this issue by ECU logic selecting a default inlet temperature value. An issue with this conservative conventional approach is that there is no evaluation of which of the mismatched parameter values is accurate. Another issue with this conservative conventional approach is that the selected parameter value (e.g., rotor speed, inlet temperature, etc.) may in fact be skewed from an actual value which in turn may lead to non-optimal engine power/thrust output or reduced efficiency.

The present disclosure provides a significant improvement that addresses scenarios such as those described above wherein a redundant sensor 34 provides mismatched parameter values that are in-range utilizing artificial intelligence. The present disclosure may utilize a variety of different AI models including those that include statistical learning methods, or heuristic methods, or the like. The present disclosure is not limited to using any particular AI model.

For a given aircraft 30 with a particular propulsion system (e.g., aircraft engine) and a given Sensor A, a database of operational parameter data is produced (e.g., through the sensors 34 and the ECU 36) and stored (e.g., in the EDR 38 and the remote system portion 32). The operational parameter database is typically produced during a number of flight missions. The number of flight missions used to accumulate an acceptable amount of parameter data for the database can vary depending upon a variety of different factors, but typically the number is chosen to provide a parameter database that is acceptable to adequately train an AI model. The present disclosure may be used with a variety of different aircraft, or with a particular aircraft having a plurality of different configurations, and therefore is not limited to any particular aircraft/aircraft configuration. An AI model may be trained for each aircraft/aircraft configuration.

As stated above, the EDR 38 is configured with an AI model for the parameter under consideration (e.g., Parameter A). In the event a redundant sensor 34 provides mismatched parameter values (e.g., in Channels A and B), the ECU 36 is configured to request the EDR 38 produce a predicted value for the mismatched in-range parameter values. To produce the predicted parameter value, the EDR 38 uses the AI model trained for Parameter A. The AI model uses or is based on the database of operational parameter data collected from previous flight missions and may take into account other factors including current operational conditions. The predicted value based on previous flight mission operational parameter data, and in some instances current operational conditions, provides information to the ECU 36 that can be used to evaluate which of the mismatched in-range parameter values is more appropriate for further processing as part of the control of the engine. The ECU 36 may be configured to then use that information in its selection of one of the mismatched in-range parameter values for further processing as part of the control of the engine. In this manner, the present disclosure is operable to improve the performance of the ECU 36 and likely the performance and reliability of the aircraft engine as well.

In some embodiments, embodiments of the present disclosure may be configured to periodically update the AI model used within the EDR 38 based on parameter data collected from additional aircraft flight missions. For example, over time an aircraft 30 may be operated numerous times within a variety of different flight missions. Embodiments of the present disclosure may be configured such that parameter data collected from these additional flight missions may be downloaded to the remote system portion 32. Within the remote system portion 32 the aforesaid collected parameter data may be processed (e.g., characterized by technicians, or synthesized, or the like) into a form (e.g., an executable file) acceptable to be input into the EDR AI model. This parameter data can then be uploaded to the EDR 38 and the EDR AI model can be updated using the same. The present disclosure is not limited to this example of how the EDR AI model may be updated. For example, as an alternative the remote system portion 32 may also have a copy of the EDR AI model. In this case, the parameter data in form to be input into the AI model may be incorporated into the AI model residing within the remote system portion 32 for updating purposes. The now updated AI model residing within the remote system portion 32 may then be used to update the AI model disposed within the EDR 38.

In some embodiments, the updating of the EDR AI model may be performed on a periodic scheduled basis, or the updating of the EDR AI model may be performed on a “need” basis (e.g., based on collected sensor data—including the event of a redundant sensor 34 producing mismatched parameter data), or both. As indicated above, the present disclosure provides a methodology for selecting a parameter data value produced by a redundant sensor 34 when the redundant sensor 34 produces mismatched parameter values, albeit parameter values that are in-range. In this manner, the present disclosure permits continued operation of the aircraft 30 and its engine(s) despite the fact that a redundant sensor 34 is providing mismatched parameter values. In other words, the present disclosure provides a methodology that permits evaluation of parameter values and a selection of a redundant parameter value with confidence based on historical flight data. In this manner, it is understood that the present disclosure can positively affect the performance of the aircraft 30 and increase the operational reliability of the aircraft engine.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details. As an example, the present disclosure is described above with the EDR 38 having an AI model. In alternative embodiments, the AI model may be disposed within the aircraft control system outside of the EDR 38 but in communication with the EDR 38.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements.

1. A method for processing parameter values from a redundant sensor configured to sense a parameter used in the control of an aircraft engine, the redundant sensor disposed within an aircraft, comprising:
producing a plurality of parameter values from a redundant sensor, the plurality of parameter values including first parameter values and second parameter values produced by the redundant sensor sensing the same parameter at the same time;
identifying mismatched parameter values from the plurality of parameter values, wherein the mismatched parameter values include a respective said first parameter value and a respective said second parameter value produced by sensing the same parameter at the same time and the respective said first parameter value and the respective said second parameter value do not equal one another;
producing a predicted parameter value using an artificial intelligence (AI) model having a database of parameter values representative of the sensed parameter;
providing the predicted parameter value to a control unit; and
operating the control unit to select the respective said first parameter value or the respective said second parameter value using the predicted parameter for use in the control of the aircraft engine.

2. The method of claim 1, wherein the redundant sensor has a plurality of channels and the respective said first parameter value is produced by a first channel of the redundant sensor and the respective said second parameter value is produced by a second channel of the redundant sensor.

3. The method of claim 1, wherein the database of parameter values representative of the sensed parameter includes data representative of parameter values previously collected from the aircraft.

4. The method of claim 3, wherein the predicted parameter value is at least in part based on the data representative of parameter values previously collected from the aircraft included within the database.

5. The method of claim 4, wherein the predicted parameter value is at least in part based on operational data values collected at the time the mismatched parameter values are produced.

6. The method of claim 1, further comprising storing the plurality of parameter values from the redundant sensor produced during a mission of the aircraft.

7. The method of claim 6, further comprising downloading the stored plurality of parameter values from the redundant sensor produced during the mission of the aircraft to a remote system portion for processing into a form for updating the AI model.

8. The method of claim 7, wherein the remote system portion is ground based, cloud based, or some combination thereof.

9. The method of claim 1, further comprising storing the plurality of parameter values from the redundant sensor produced during a mission of the aircraft and updating the AI model based on the plurality of parameter values from the redundant sensor produced during the mission of the aircraft.

10. The method of claim 1, wherein the plurality of parameter values from the redundant sensor are within a range indicating that a sensed portion of the aircraft engine is operating properly.

11. The method of claim 1, wherein the sensed parameter is one or more of pressure, temperature, aircraft altitude, speed, acceleration, power, torque, weight, or aircraft ambient conditions.

12. A control system for an aircraft engine of an aircraft, the control system comprising:
an electronic control unit (ECU);
a redundant sensor disposed within the aircraft and in communication with the ECU, the redundant sensor configured to sense a parameter used in the control of the aircraft engine, and to produce a plurality of parameter values including first parameter values and second parameter values by sensing the parameter at the same time; and
an engine data recorder (EDR) in communication with the ECU, the EDR having an artificial intelligence (AI) model having a database of parameter values representative of the sensed parameter;
wherein the ECU is configured to identify mismatched parameter values from the redundant sensor, wherein the mismatched parameter values include a respective said first parameter value and a respective said second parameter value produced by sensing the same said parameter at the same time and the respective said first parameter value and the respective said second parameter value do not equal one another; and
wherein the EDR is configured to produce a predicted parameter value using the AI model and to selectively communicate the predicted parameter value to the ECU; and
wherein the ECU is configured to select the respective said first parameter value or the respective said second parameter value using the predicted parameter for use in the control of the aircraft engine.

13. The control system of claim 12, wherein the redundant sensor has a plurality of channels and the respective said first parameter value is produced by a first channel of the redundant sensor and the respective said second parameter value is produced by a second channel of the redundant sensor.

14. The control system of claim 12, wherein the database of parameter values representative of the sensed parameter includes data representative of parameter values previously collected from the aircraft.

15. The control system of claim 14, wherein the predicted parameter value is at least in part based on the data representative of parameter values previously collected from the aircraft included within the database.

16. The control system of claim 12, wherein the EDR is configured to store the plurality of parameter values from the redundant sensor produced during a mission of the aircraft, and is configured to selectively download the stored plurality of parameter values from the redundant sensor to a remote system portion for processing into a form for updating the AI model.

17. The control system of claim 12, wherein the EDR is configured to store the plurality of parameter values from the redundant sensor produced during a mission of the aircraft and to update the AI model based on the plurality of parameter values.

18. The control system of claim 12, wherein the plurality of parameter values from the redundant sensor are within a range indicating that a sensed portion of the aircraft engine is operating properly.

19. The control system of claim 12, wherein the sensed parameter is one or more of pressure, temperature, aircraft altitude, speed, acceleration, power, torque, weight, or aircraft ambient conditions.

20. A method for processing parameter values from redundant sensors configured to sense a parameter used in the control of an aircraft engine, the redundant sensors disposed within an aircraft, comprising:
producing a plurality of first parameter values from a first sensor configured to sense a parameter;
producing a plurality of second parameter values from a second sensor configured to sense the parameter;
wherein the first sensor and the second sensor are configured to be redundant, sensing the parameter at the same time;
identifying a mismatch between the first parameter values and the second parameter values, wherein the first parameter values and the second parameter values produced by sensing the parameter at the same time do not equal one another;
producing a predicted parameter value using an artificial intelligence (AI) model having a database of parameter values representative of the sensed parameter;
providing the predicted parameter value to a control unit; and
operating the control unit to select at least one of the first parameter values or at least one of the second parameter values using the predicted parameter for use in the control of the aircraft engine.
